(19) United States
(12) Patent Application Publication
(10) Pub. No.: US 2021/0091357 A1
(43) Pub. Date: Mar. 25, 2021

(54) BATTERY UNIT AND SECONDARY BATTERY

(71) Applicant: KABUSHIKI KAISHA TOSHIBA, Minato-ku (JP)

(72) Inventors: Kenya UCHIDA, Yokohama (JP); Ikuo Uematsu, Yokohama (JP); Wataru Nitta, Tokyo (JP)

(73) Assignee: KABUSHIKI KAISHA TOSHIBA, Minato-ku (JP)

(21) Appl. No.: 16/916,362

(22) Filed: Jun. 30, 2020

(30) Foreign Application Priority Data
Sep. 19, 2019 (JP) 2019-170752

(51) Int. Cl. H01M 2/16; H01M 4/131; H01M 4/485; H01M 10/0525; H01M 4/62

(52) U.S. Cl. CPC H01M 2/162; H01M 2/1673; H01M 4/131; H01M 2004/021; H01M 10/0525; H01M 4/628; H01M 4/485

(57) ABSTRACT

According to an embodiment, a battery unit is provided. The battery unit includes an electrode structure and a substrate. The electrode structure includes a first electrode and an organic fiber film. The first electrode includes an active material-containing layer. The organic fiber film is provided on the active material-containing layer. The substrate is in contact with the organic fiber film. A coefficient of kinetic friction between the electrode structure and the substrate is 0.8 or less. Elongation amount S of the organic fiber film and thickness T of the first electrode satisfies the following equation (1):

S≥π×T/4 (1)

### CROSS-REFERENCE TO RELATED APPLICATIONS

This application is based upon and claims the benefit of priority from Japanese Patent Application No. 2019-170752, filed Sep. 19, 2019, the entire contents of which are incorporated herein by reference.

### FIELD

Embodiments described herein relate generally to a battery unit and a secondary battery.

### BACKGROUND

In a secondary battery such as a lithium secondary battery, a porous separator is disposed between a positive electrode and a negative electrode to avoid contact between the positive and negative electrodes. For a separator, a self-supporting film separately from the positive and negative electrodes is used. Examples thereof include a porous film made of a polyolefin-based resin. Such a separator is produced, for example, by extruding a melt containing a polyolefin-based resin composition into a sheet, extracting and removing substances other than the polyolefin-based resin, and stretching the sheet.

Since it is necessary for a separator made of a resin film to have mechanical strength so as not to break during production of a battery, it is difficult to thin the separator beyond a certain level. The positive electrode and the negative electrode are laminated or wound while the separator is interposed therebetween; therefore, if the separator is thick, the number of layers of the positive electrode and the negative electrode that can be stored per unit volume of the battery is limited. As a result, the battery capacity is reduced. In addition, the separator made of the resin film has poor durability, and if used in the secondary battery, the separator deteriorates as the charge and discharge are repeated, and the cycle property of the battery deteriorates.

In order to reduce the thickness of the separator, integration of a nanofiber film on either the positive electrode or the negative electrode is being considered.

### BRIEF DESCRIPTION OF THE DRAWINGS

FIG. 1 is a cross-sectional view schematically illustrating an example of a battery unit according to an embodiment;

FIG. 2 is a cross-sectional view for explaining a state in which a coefficient of kinetic friction is measured;

FIG. 3 is a cross-sectional view schematically illustrating an example of a wound-type electrode group;

FIG. 4 is a cross-sectional view illustrating part of the wound-type electrode group of FIG. 3 in an enlarged manner;

FIG. 5 is a cross-sectional view illustrating a first electrode included in the wound-type electrode group of FIG. 4 in an enlarged manner;

FIG. 6 is a perspective view of the first electrode included in the battery unit of FIG. 1;

FIG. 7 is a cross-sectional view schematically illustrating an example of a modification of the first electrode;

FIG. 8 is a cross-sectional view schematically illustrating another example of the modification of the first electrode;

FIG. 9 is a cross-sectional view schematically illustrating an example of an electrode group according to the embodiment;

FIG. 10 is an exploded perspective view illustrating an example of a secondary battery according to the embodiment; and

FIG. 11 is a partially-cut perspective view illustrating another example of the secondary battery according to the embodiment.

### DETAILED DESCRIPTION

According to the embodiment, a battery unit including an electrode structure and a substrate is provided. The electrode structure includes a first electrode and an organic fiber film. The first electrode includes an active material-containing layer. The organic fiber film is provided on the active material-containing layer. The substrate is in contact with the organic fiber film. A coefficient of kinetic friction between the electrode structure and the substrate is 0.8 or less. Elongation amount S of the organic fiber film and thickness T of the first electrode satisfy the following equation (1):

S≥π×T/4 (1)

According to another embodiment, a secondary battery is provided. The secondary battery of the embodiment includes a battery unit of the embodiment.

An organic fiber film provided on an active material-containing layer of an electrode is, in a manner similar to a self-supporting film type separator, disposed to be positioned between a pair of electrodes, and functions to prevent a short circuits between the electrodes. In particular, a non-self-supporting type organic fiber film directly provided on an active material-containing layer of an electrode requires no mechanical strength, and can thus be formed to be thinner than the self-supporting film type separator.

However, there is room for improvement in the function of short circuit prevention of the organic fiber film. That is, when external stress is applied to an electrode group including an electrode structure having an organic fiber film and an electrode and also including an electrode opposed to the electrode structure, the organic fiber film may peel off from the active material-containing layer, causing an internal short circuit.

In respect to this problem, the inventors had conducted extensive and intensive studies, finding that two problems of peeling off and breakage of the organic fiber film occur when stress is applied to the electrode structure and the opposed electrode in a manner causing displacement opposite to each other in a horizontal direction.

That is, when the electrode structure and the opposed electrode are displaced in horizontally opposite directions, a relatively large friction force is generated on a contact surface between the organic fiber film of the electrode structure and the opposed electrode. When the friction force exceeds an adhesion between the organic fiber film and the active material-containing layer, this may result in the organic fiber film peeling off from the active material-containing layer. Furthermore, when displacement in the opposite directions occurs, the shape of the electrode structure changes, for example, into a bent form. If the organic fiber film cannot track the shape change of the active material-containing layer, part of the organic fiber film may break.

### First Embodiment

According to the embodiment, a battery unit including an electrode structure and a substrate is provided. The electrode structure includes a first electrode and an organic fiber film. The first electrode includes an active material-containing layer. The organic fiber film is provided on the active material-containing layer. The substrate is in contact with the organic fiber film. A coefficient of kinetic friction between the electrode structure and the substrate is 0.8 or less. Elongation amount S of the organic fiber film and thickness T of the first electrode satisfy the following equation (1):

S≥π×T/4 (1)

The battery unit according to the embodiment can suppress both the peeling off and breakage of the organic fiber film and can therefore suppress an internal short circuit of the battery. Hereinafter, the reason thereof will be described in detail with reference to the accompanying drawings.

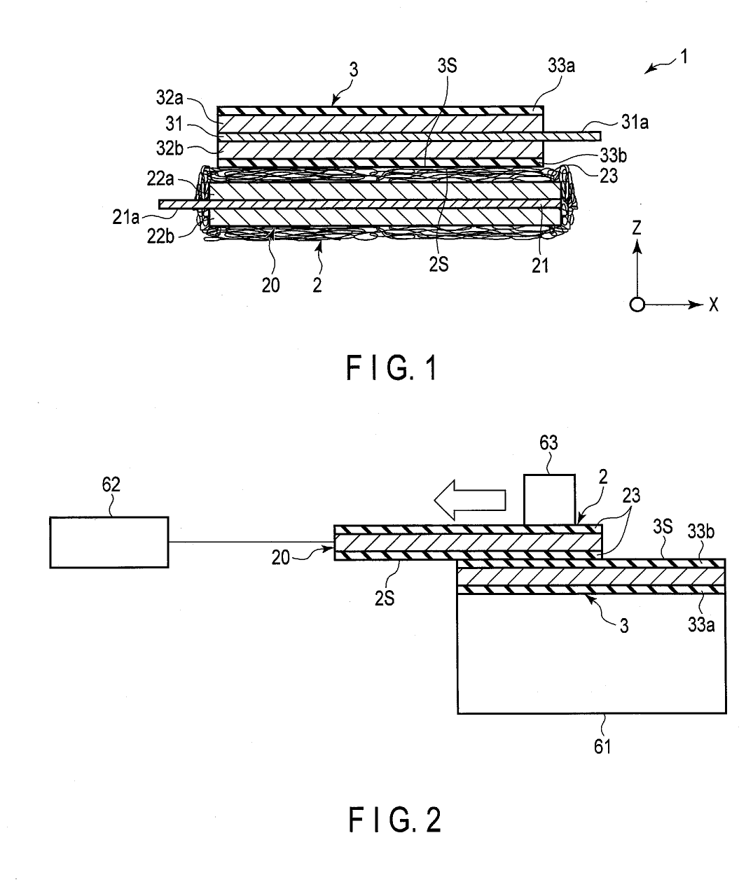

FIG. 1 is a cross-sectional view schematically illustrating an example of a battery unit according to the embodiment. A battery unit 1 illustrated in FIG. 1 includes an electrode structure 2 and a second electrode 3. The electrode structure 2 and the second electrode 3 are laminated in Z direction. The Z direction is a thickness direction of the battery unit 1 while X direction is a short-side direction of the battery unit 1. The Z and X directions are orthogonal to each other.

The electrode structure 2 includes a first electrode 20 and an organic fiber film 23. The first electrode 20 includes a current collector 21, and active material-containing layers 22a and 22b formed on both surfaces of the current collector 21. The current collector 21 includes a portion not covered with the active material-containing layers 22a and 22b, i.e., a current collector tab 21a. The organic fiber film 23 is provided to cover the entire first electrode 20 except a part of the current collector tab 21a.

The second electrode 3 is an example of a substrate. The second electrode 3 includes a current collector 31, active material-containing layers 32a and 32b provided on both surfaces of the current collector 31, and insulating layers 33a and 33b covering each of principal surfaces of the active material-containing layers 32a and 32b of the both surfaces. The electrode structure 2 and the second electrode 3 are laminated in such a manner that at least a part of one insulating layer 33b is in contact with the organic fiber film 23 while the current collector tabs 21a and 31a extend in opposite directions.

For the substrate, a separator may be used instead of the second electrode 3. The second electrode 3 may omit the insulating layers 33a and 33b or may include an organic fiber film instead of the insulating layers 33a and 33b, or the surfaces of the insulating layers 33a and 33b may be covered with the organic fiber film.

The inventors found that when a coefficient of kinetic friction between the electrode structure 2 and the substrate, i.e., a coefficient of kinetic friction between surface 2S of the electrode structure 2 and surface 3S of the second electrode 3 illustrated in FIG. 1 is 0.8 or less, the organic fiber film 23 does not easily peel off from the active material-containing layer 22a. Kinetic friction coefficient μ, kinetic friction force F, and vertical load N have the relationship of the following equation (I):

F=μN (I)

As is apparent from the equation (I), the smaller the kinetic friction coefficient μ is, the smaller the kinetic friction force F is. The kinetic friction coefficient μ is preferably 0.8 or less, more preferably 0.75 or less. The kinetic friction coefficient μ particularly has no lower limit value, an example of which is 0.6 or more.

The kinetic friction coefficient μ can be measured by, for example, the following method.

First, a secondary battery is dissembled, and an electrode group is extracted. If the electrode group is a wound-type electrode group, the electrode group is developed into a sheet shape. A part of the extracted electrode group is cut, then washed with a solvent such as methylethyl carbonate, and subsequently dried. If the electrode group is a wound-type electrode group, a portion with no folding line in the electrode group is cut.

The battery unit is removed from the cut electrode group, and is attached as illustrated in FIG. 2 to a measuring apparatus. FIG. 2 is a cross-sectional view for explaining a state of a coefficient of kinetic friction being measured. In FIG. 2, the battery unit of FIG. 1 is used as an example of a measured sample. On a measuring table 61, the second electrode 3 as the substrate is fixed in such a manner that the surface 3S which was in contact with the electrode structure 2 is an upper surface. In the electrode structure 2, the surface 2S which was in contact with the substrate is a lower surface, and laminated on the second electrode 3 to come into contact with the surface 3S. A load cell 62 is coupled to one end of the electrode structure 2. A single-axis actuator (not shown) is coupled to the load cell 62.

When the kinetic friction coefficient μ is measured, a balancing weight 63 is placed on the electrode structure 2. The weight of the balancing weight 63 is, for example, 10 g. With the balancing weight 63 being placed, the single-axis actuator (not shown) is activated to swing the electrode structure 2 in an arrow direction. A swing distance is, for example, 15 cm. In this manner, the kinetic friction force F of the contact surface between the electrode structure 2 and the second electrode 3 is obtained. Based on the above-described equation (I), the kinetic friction coefficient μ can be calculated.

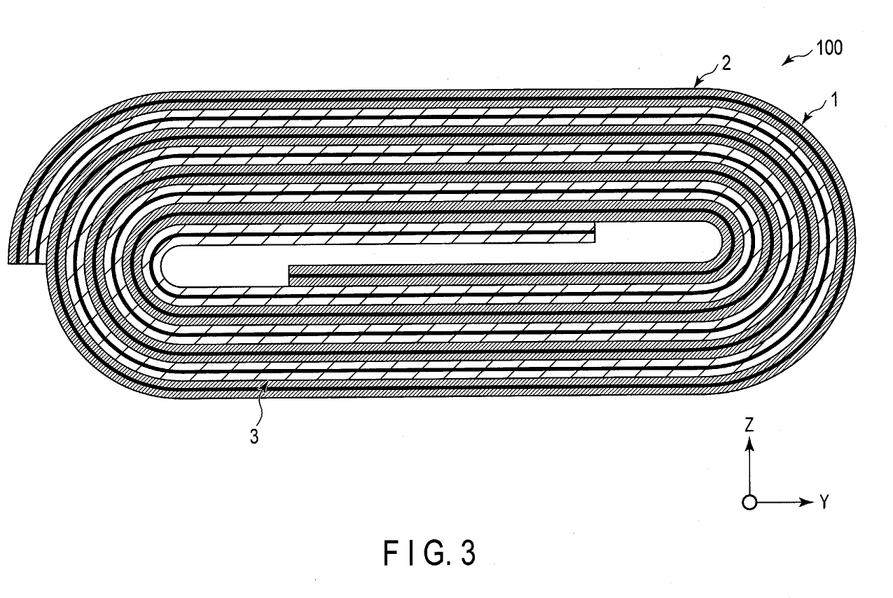

Furthermore, the inventors found that when the elongation amount S of the organic fiber film satisfies the equation (1), the organic fiber film does not easily break. In other words, it is sufficient that the elongation amount S of the organic fiber film is π/4 or more of the thickness T of the first electrode. The reason thereof will be described with reference to FIGS. 3 to 5.

When external stress is applied, the shape of the electrode structure may change. An example thereof is when a wound-type electrode group is produced by winding an electrode group including an electrode structure and a substrate. FIG. 3 is a cross-sectional view schematically showing an example of a wound-type electrode group. A wound-type electrode group 100 illustrated in FIG. 3 is obtained by winding the battery unit 1 of FIG. 1 with the X-axis direction as an winding axis so that the electrode structure 2 is on the outer side, followed by pressing process. The Y-axis direction is a long-side direction of the battery unit 1, and orthogonal to the X-axis direction and the Z-axis direction.

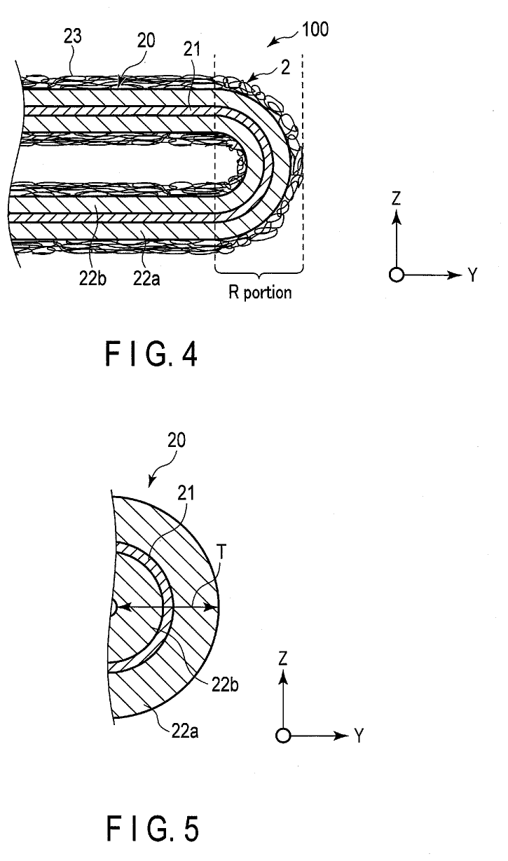

FIG. 4 is a cross-sectional view illustrating part of the wound-type electrode group of FIG. 3 in an enlarged manner. FIG. 4 is an enlarged view of the wound-type electrode group 100 in the vicinity of the folding line of the innermost circumference of the electrode structure 2. In the wound-type electrode group 100, a portion excluding a linearly extending part is referred to as a bent portion, so-called R portion. The inventors found that the organic fiber film 23 easily breaks in the vicinity of the R portion of the innermost circumference.

FIG. 5 is a cross-sectional view illustrating the first electrode included in the wound-type electrode group of FIG. 4 in an enlarged manner. FIG. 5 illustrates the R portion of the innermost circumference of FIG. 4 in a further enlarged manner. As illustrated in FIG. 5, in the R portion, the first electrode 20 is bent in an arc with a top part of the innermost circumference as a center. Thus, as illustrated in FIG. 5, the R portion has a half-circle cross section. Assuming that the first electrode 20 draws a half circle in the R portion, length L1 of the outer circumference of the R portion of the first electrode 20 is represented by the following equation (2). In the equation (2), T denotes a thickness of the first electrode 20.

L1=T×π (2)

When the active material-containing layers 22a and 22b having a uniform thickness are provided on both surfaces of the current collector 21, length. L2 of the R portion of the current collector 21 is represented by the following equation (3) ignoring the thickness of the current collector 21.

L2=T/2×π (3)

The current collector 21 of the first electrode 20 is typically a metal foil, and therefore does not elongate by bending of the electrode structure 2. Accordingly, elongation amount L3 of the active material-containing layer 22a located on the outer circumferential side of the R portion of the first electrode 20 is a difference between the lengths L1 and L2 as indicated by the following equation (4):

L3=L2−L1=T/2×π (4)

That is, in the R portion of the first electrode 20, the outer circumferential part of the first electrode 20 elongates by T/2×π. If the elongation amount L3 is larger, a fracture may be caused on the surface of the active material-containing layer 22a on the outer circumferential side of the first electrode 20.

The inventors found that the organic fiber film 23 does not easily break when the elongation amount S of the organic fiber film 23 covering the active material-containing layer 22a on the outer circumferential side of the first electrode 20 is T/4×π or more. Furthermore, if the elongation amount S of the organic fiber film 23 is T/4×π or more, even when a fracture is caused on the surface of the active material-containing layer 22a by bending, this fracture can be covered with the organic fiber film 23, rendering an internal short circuit less likely to occur.

The elongation amount S of the organic fiber film is preferably T/4×π or more, more preferably 1.5T/4×π or more, even more preferably T/2×π or more. The elongation amount S of the organic fiber film particularly has no upper limit value, an example of which is 3 mm. The units of the elongation amount S of the organic fiber film 23, the length L1 of the outer circumference of the first electrode 20, the length L2 of the current collector 21 of the R portion, and the elongation amount L3 of the active material-containing layer located on the outer circumferential side of the R portion of the first electrode 20 is the same as the unit of the thickness T of the first electrode 20, and the unit is μm, for example.

The elongation amount S of the organic fiber film can be measured by, for example, the following method.

First, in the same manner as described above, the electrode group is extracted from the secondary battery, a part thereof is cut, then washed, and subsequently dried. The electrode structure is extracted from the cut electrode group and cut out into a shape of a test piece for a tensile test. The shape of the test piece for a tensile test is, for example, a dumbbell shape in which large areas are connected to both ends of a thin strip. For the test piece, for example, dumbbell test piece #3 regulated in JIS B 6251 or the like may be used. The test piece is set on a tensile tester, and one end is pulled at a constant speed while the load applied to one end is measured with a load cell. When one end of the test piece is pulled, because of the elongation amount of the first electrode being smaller than the elongation amount S of the organic fiber film, the first electrode breaks first, and the organic fiber film breaks afterwards. When these breakages occur, a large load is measured. Therefore, when a large load is measured the second time after the start of measurement, it is assumed that a breakage of the organic fiber film occurs, and that the moving distance of one end at this time is set to an elongation amount S of the organic fiber film. The tensile velocity is, for example, 4 mm/min.

Hereinafter, details of the battery unit according to the embodiment will be described.

(First Electrode)

The first electrode includes a current collector, and an active material-containing layer provided on at least one principal surface of the current collector. It is preferable that the active material-containing layer is provided on both surfaces, and it is preferable that each active material-containing layer has an equal thickness. The active material-containing layer has a thickness of, for example, 5 μm or more and 100 μm or less.

The first electrode may be a positive or negative electrode. The positive and negative electrodes contain active materials of different types. The types of active materials may be one type, or two or more types.

As the positive electrode active material, for example, a lithium transition metal composite oxide is used. For example, there are LiCoO₂, LiNi₁₋ₓCoₓO₂ (0<x<0.3), LiMnₓNi_{y}Co_{z}O₂ (0<x<0.5, 0<y<0.5, 0≤z<0.5), LiMn₂₋ₓMₓO₄ (M is at least one element selected from the group consisting of Mg, Co, Al, and Ni, 0<x<0.2), LiMPO₄ (M is at least one element selected from the group consisting of Fe, Co, and Ni), and the like.

It is more preferable that the first electrode is a negative electrode that contains at least one of a titanium-containing oxide or a niobium titanium-containing oxide as a negative electrode active material. Examples of the titanium-containing oxide include Li₄₊ₓTi₃O₁₂ (0≤x≤3) having a spinel structure, and Li_{2+y}Ti₃O₇ (0≤y≤3) having a ramsdellite structure. Examples of the niobium titanium-containing oxide include monoclinic TiNb₂O₇.

It is possible, as the negative electrode active material, to use carbon materials including graphite, tin-silicon alloy materials, and the like, other than the titanium-containing oxide and the niobium titanium-containing oxide.

The active material may be independent primary particles, secondary particles as agglomerates of primary particles, or a mixture of the primary particles and the secondary particles.

An average particle size of primary particles of the negative electrode active material is preferably in the range of 0.001 μm or more and 1 μm or less. The average particle size can be obtained by, for example, observing the negative electrode active material using a SEM. The shape of particles may be a granular shape or a fibrous shape. In the case of the fibrous shape, the dimeter of fibers is preferably 0.1 μm or less. Specifically, the average particle size of the primary particles of the negative electrode active material can be measured from an image observed with a scanning electron microscope (SEM). When the titanium-containing oxide and the niobium titanium-containing oxide having an average particle size of 1 μm or less is used as the negative electrode active material, a negative electrode active material-containing layer having high surface flatness can be obtained. In addition, when the titanium-containing oxide and the niobium titanium-containing oxide are used, a negative electrode potential is nobler than that of a lithium ion secondary battery using a common carbon negative electrode; therefore, precipitation of lithium metal does not occur in principle. The negative electrode active material containing the titanium-containing oxide and the niobium titanium-containing oxide can be prevented from collapsing the crystal structure of the active material because the expansion and contraction associated with the charge-and-discharge reaction is small.

The active material-containing layer may contain a binder and a conductive agent in addition to the active material. Examples of the conductive agent can include acetylene black, carbon black, graphite, or mixtures thereof. Examples of the binder include polytetrafluoroethylene (PTFE), polyvinylidene fluoride (PVdF), fluorine-containing rubber, styrene-butadiene rubber, and mixtures thereof. The binder has a function of binding the active material and the conductive agent.

Examples of the current collector include a foil made of a conductive material. Examples of the conductive material include aluminum and an aluminum alloy. The current collector tab is preferably made of the same material as the current collector. The current collector tab may be provided by preparing a metal foil separately from the current collector and connecting it to the current collector by welding or the like. The thickness of the current collector is, for example, from 5 μm to 40 μm.

The thickness T of the first electrode is preferably from 15 μm to 240 μm, more preferably from 30 μm to 200 μm. If the thickness T of the first electrode is within this range, it is possible to obtain a battery with excellent energy density and rate performance. That is, the elongation amount S of the organic fiber film is preferably 150 μm or more, more preferably 200 μm or more.

(Organic Fiber Film)

The organic fiber film includes one or more organic fibers. The organic fiber film may be a porous film obtained by depositing organic fibers in a plane direction. The organic fiber film is preferably a non-self-supporting type film directly provided on the active material-containing layer of the first electrode by an electrospinning method described below.

It is preferable that the organic fibers are partially buried in the active material-containing layer. This can enhance the adhesion between the organic fiber film and the active material-containing layer. This can be confirmed by, for example, observation with a focused ion beam (FIB) device.

Examples of the organic fibers include at least one organic material selected from the group consisting of polyamideimide, polyamide, polyolefin, polyether, polyimide, polyketone, polysulfone, cellulose, polyvinyl alcohol (PVA), and polyvinylidene fluoride (PVdF). Examples of polyolefin include polypropylene (PP) and polyethylene (PE). The kind of the organic fibers can be one kind or two or more kinds. Preferable examples include at least one kind selected from the group consisting of polyimide, polyamide, polyamideimide, cellulose, PVdF, and PVA, and more preferable examples include at least one kind selected from the group consisting of polyimide, polyamide, polyamideimide, cellulose, and PVdF.

Polyimide is insoluble or infusible at 250 to 400° C. and does not decompose, therefore allowing for an organic fiber film having excellent heat resistance to be obtained.

For the organic fibers, it is preferable that the length is 1 mm or more and the average diameter is 2 μm or less, more preferably the average diameter of 1 μm or less. The organic fiber film has sufficient strength, porosity, air permeability, pore size, electrolytic solution resistance, redox resistance, and the like, and therefore functions well as the separator. The average diameter of the organic fibers can be measured by observation with a focused ion beam (FIB) device. The length of the organic fibers can be obtained based on measurement by observation with the FIB device.

From the viewpoint of securing ion permeability and electrolyte retention, 30% or more of the volume of the entire fibers forming the organic fiber film is preferably organic fibers having an average diameter of 1 μm or less, more preferably organic fibers having an average diameter of 350 nm or less, even more preferably organic fibers having an average diameter of 50 nm or less.

In addition, it is more preferable that the volume of the organic fiber having an average diameter of 1 μm or less (more preferably 350 nm or less, even more preferably 50 nm or less) occupies 80% or more of the volume of the entire fiber forming the organic fiber film. Such a state can be examined by scanning ion microscope (SIM) observation of the organic fiber film. It is more preferable that the organic fiber having a thickness of 40 nm or less occupies 40% or more of the volume of the entire fiber forming the organic fiber film. The diameter of the organic fiber being small means that the influence of interfering with the movement of ions is small.

A cation exchange group is preferably present on at least a part of the entire surface including the front surface and the back surface of organic fiber. The movement of ions such as lithium ions passing through the separator is promoted by the cation exchange group, thereby improving the performance of the battery. Specifically, rapid charge and rapid discharge can be performed for a long period of time. The cation exchange group is not particularly limited, but examples thereof include a sulfonate group and a carboxylate group. Fibers having the cation exchange group on the surface thereof can be formed by, for example, an electrospinning method using a sulfonated organic material.

The organic fiber film has vacancies, the average pore size of which is preferably from 5 nm to 10 μm. In addition, the porosity is preferably from 70% to 90%. If such vacancies are provided, a separator having excellent ion permeability and excellent electrolyte impregnating property can be obtained. The porosity is more preferably 80% or more. The average pore size and porosity of the vacancies can be examined by a mercury intrusion porosimetry, calculation from volume and density, SEM observation, SIM observation, or a gas absorption method. The porosity is preferably calculated from the volume and density of the organic fiber film. In addition, it is preferable to measure the average pore size by a mercury intrusion method or a gas adsorption method. The high porosity of the organic fiber film means that the influence of interfering ion migration is small.

The thickness of the organic fiber film is preferably within the range of 12 μm or less, more preferably 5 μm or less. The lower limit of the thickness is not particularly limited, but may be 1 μm. The thickness of the organic fiber film is measured by a method in accordance with the JIS standard (JIS B 7503-1997). Specifically, these thicknesses are measured by using a contact digital gauge. The material is placed on a stone plate and the digital gauge fixed to the stone plate is used. Using a flat-shaped measuring terminal with a tip of 5.0 mm diameter, the measurement terminal is brought towards the sample from a distance of 1.5 mm or more and less than 5.0 mm above the sample, and the distance at which the measurement terminal comes into contact with the sample is the thickness of the sample.

In the organic fiber film, if the contained organic fibers are made sparse, the porosity is increased, and it is thus not difficult to obtain a layer having, for example, a porosity of about 90%. It is extremely difficult to form such a layer having a large porosity using particles.

The organic fiber film has advantages over inorganic fiber deposits in terms of irregularities, cracking tendency, electrolyte holding, adhesion, bending properties, porosity, and ion permeability.

The organic fiber film may contain particles of an organic compound. The particles are made of, for example, the same material as the organic fiber. The particles may be integrally formed with the organic fibers.

The organic fiber film is provided to cover at least a part of the principal surface of the active material-containing layer. It is preferable that the organic fiber film covers the entire principal surface of the active material-containing layer. At least a part of the organic fiber film is positioned to come into contact with both the active material-containing layer of the first electrode and the substrate.

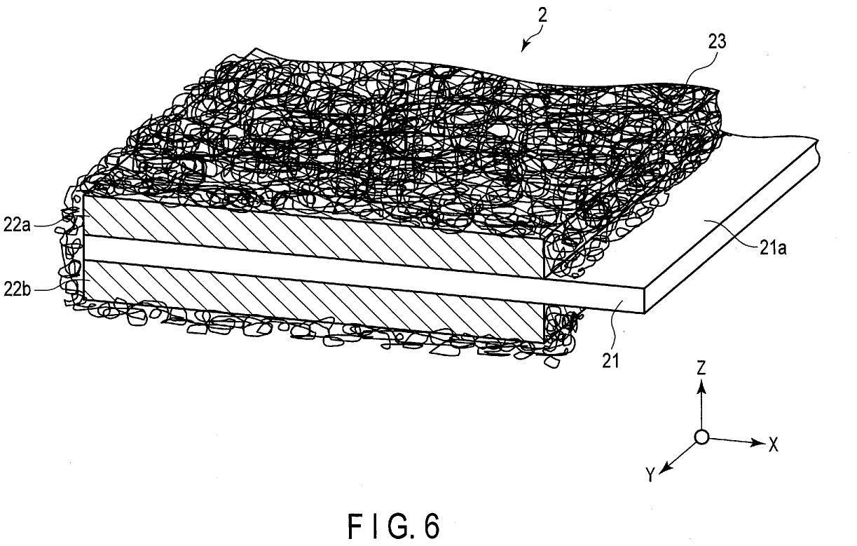

It is preferable that the organic fiber film is provided as illustrated in FIGS. 1 and 6. FIG. 6 is a perspective view of the first electrode included in the battery unit of FIG. 1. As illustrated in FIGS. 1 and 6, the organic fiber film 23 covers the principal surfaces of the active material-containing layers 22a and 22b provided on both surfaces of the current collector 21, the side surfaces of the active material-containing layers 22a and 22b along the Y-axis direction, a part of both surfaces of the current collector tab 21a, and the side surface of the current collector 21 along the Y-axis direction. The organic fiber film 23 may or may not cover the side surfaces of the active material-containing layers 22a and 22b along the X-axis direction.

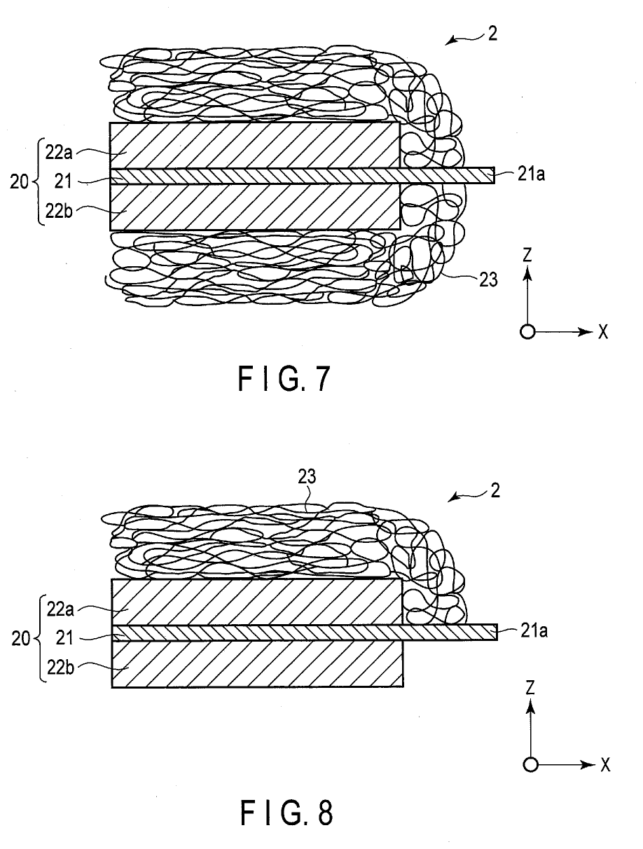

The first electrode may have a structure illustrated in FIG. 7. FIG. 7 is a cross-sectional view schematically illustrating an example of a modification of the first electrode. A first electrode 2 illustrated in FIG. 7 has a structure similar to that of FIGS. 1 and 7 except that the organic fiber film 23 is not provided on the side surfaces of the active material-containing layers 22a and 22b and the current collector 21 on a side with no current collector tab 21a.

The first electrode may have a structure illustrated in FIG. 8. FIG. 8 is a cross-sectional view schematically illustrating another example of the modification of the first electrode. In the first electrode 2 illustrated in FIG. 8, an organic fiber film 23 is provided on one principal surface of the active material-containing layer 22a, one side surface of the active material-containing layer 22a on a side with the current collector tab 21a, and a part of one principal surface of the current collector tab 21a.

(Substrate)

The substrate faces the first electrode through the organic fiber film. At least a part of the substrate is in contact with the organic fiber film.

The substrate is, for example, the second electrode or the separator. If the substrate is the second electrode, the battery unit according to the embodiment is also referred to an electrode group. It is preferable that the substrate is the second electrode.

(Second Electrode)

The second electrode is a positive electrode if the first electrode is a negative electrode. The second electrode is a negative electrode if the first electrode is a positive electrode. The second electrode is preferably a positive electrode. The second electrode may include a current collector and an active material-containing layer provided on at least one principal surface of the current collector. The active material-containing layer includes a positive electrode active material or a negative electrode active material. The active material-containing layer may further include at least one of a conductive agent or a binder. The same as described above may be used for the current collector, the positive electrode active material, the negative electrode active material, the conductive agent and the binder that may be included in the second electrode.

The active material-containing layer of the second electrode is preferably located in contact with the organic fiber film of the electrode structure. That is, the coefficient of kinetic friction between the electrode structure and the substrate described above is a coefficient of kinetic friction between the organic fiber film of the electrode structure and the active material-containing layer of the second electrode.

(Insulating Layer)

It is preferable that the second electrode includes the insulating layer. The insulating layer is positioned on the outermost surface of the second electrode. The insulating layer covers at least a part of the principal surface of the active material-containing layer of the second electrode. The insulating layer preferably covers the entire surface of the active material-containing layer. If the active material-containing layers are provided on both surfaces of the current collector, it is preferable that the insulating layers are provided on the principal surfaces of the active material-containing layers of both surfaces. The insulating layer is preferably positioned in contact with the organic fiber film of the electrode structure. That is, the coefficient of kinetic friction between the electrode structure and the substrate described above may be a coefficient of kinetic friction between the organic fiber film of the electrode structure and the insulating layer of the second electrode.

The insulating layer contains insulating particles. The insulating particles are, for example, inorganic materials. Examples of the inorganic material includes oxide (for example, oxide of group IIA to VA, transition metals, IIIB and IVB, such as Li₂O, BeO, B₂O₃, Na₂O, MgO, Al₂O₃, SiO₂, P₂O₅, CaO, Cr₂O₃, Fe₂O₃, ZnO, ZrO₂, TiO₂, magnesium oxide, silicon oxide, alumina, zirconia, and titanium oxide), zeolite (M_{2/n}O.Al₂O₃.xSiO₂.yH₂O (in the formula, M is a metal atom such as Na, K, Ca, and Ba, n is a number corresponding to the charge of a metal cation Mn⁺, and x and y are the number of moles of SiO₂ and H₂O, 2≤x≤10, 2≤y), nitride (for example, BN, AlN, Si₃N₄, Ba₃N₂, or the like), silicon carbide (SiC), zircon (ZrSiO₄), carbonate (for example, MgCO₃ and CaCO₃, or the like), sulfate (for example, CaSO₄ and BaSO₄, or the like), and composites thereof (for example, steatite (MgO.SiO₂), forsterite (2MgO.SiO₂), and cordierite (2MgO.2Al₂O₃. 5SiO₂) which are one type of porcelain)), tungsten oxide, or mixtures thereof.

Examples of the other inorganic materials may be barium titanate, calcium titanate, lead titanate, γ-LiAlO₂, LiTiO₃, a solid electrolyte, or a mixture thereof.

Examples of the solid electrolyte include a solid electrolyte having no or low lithium ion conductivity, and a solid electrolyte having lithium ion conductivity. Examples of oxide particles having no or low lithium ion conductivity include a lithium aluminum oxide (for example, LiAlO₂, LiₓAl₂O₃ where 0<x≤1), a lithium silicon oxide, and a lithium zirconium oxide.

Example of solid electrolytes having lithium ion conductivity include an oxide solid electrolyte having a garnet structure. The oxide solid electrolyte having a garnet structure has advantages that reduction resistance is high and an electrochemical window is wide. Examples of the oxide solid electrolyte having a garnet structure include La₅₊ₓAₓLa₃₋ₓM₂O₁₂ (A is at least one element selected from the group consisting of Ca, Sr, and Ba, M is Nb and/or Ta, and x is preferably in a range of 0.5 or less (including 0)), Li₃M₂₋ₓL₂O₁₂ (M is Nb and/or Ta, L contains Zr, and x is preferably in a range of 0.5 or less (including 0)), Li₇₋₃ₓAlₓLa₃Zr₃O₁₂ (x is preferably in a range of 0.5 or less (including 0)), and Li₇La₃Zr₂O₁₂. In particular, since Li_{6.25}Al_{0.25}La₃Zr₃O₁₂, Li_{6.4}La₃Zr_{1.4}Ta_{0.6}O₁₂, Li_{6.4}La₃Zr_{1.6}Ta_{0.6}O₁₂, and Li₇La₃Zr₂O₁₂ have high ion conductivity and are electrochemically stable, they are superior in discharge performance and cycle life performance.

Examples of solid electrolytes having lithium ion conductivity include a lithium phosphorus solid electrolyte having a NASICON structure. Examples of the lithium phosphorus solid electrolyte having a NASICON structure include LiM1₂(PO₄)₃, where M1 is one or more elements selected from the group consisting of Ti, Ge, Sr, Zr, Sn, and Al. Preferred examples thereof include Li₁₊ₓAlₓGe₂₋ₓ(PO₄)₃, Li₁₊ₓAlₓZr₂₋ₓ(PO₄)₃, and Li₁₊ₓAlₓTi₂₋ₓ(PO₄)₃. X is preferably in the range of 0 to 0.5. Each of the exemplified solid electrolytes has high ion conductivity and high electrochemical stability. Both the lithium phosphorus solid electrolyte having a NASICON structure and the oxide solid electrolyte having a garnet structure may be used as a solid electrolyte having lithium ion conductivity.

The insulating layer including at least one type of inorganic material selected from the above is a porous film including aggregates of inorganic material particles. Although inorganic materials having lithium ion conductivity exist as in solid electrolytes, for example, most inorganic materials have low electron conductivity or an insulating property. Thus, the insulating layer can function as a partition wall separating the positive electrode from the negative electrode. Therefore, by including the insulating layer, self-discharge can be suppressed.

Since the insulating layer can hold a nonaqueous electrolyte in the porous portion, permeation of Li ions is not inhibited.

The insulating layer including an inorganic material of the above type has a high insulating property while having Li ion permeability. Considering practical aspects, the insulating layer containing alumina is preferable. Furthermore, considering manufacturing process aspects, the insulating layer containing titanium oxide is also preferable.

The form of the inorganic material may be, for example, granular or fibrous.

An average particle size D50 of inorganic material particles may be 0.5 μm or more and 2 μm or less.

The content of the inorganic material in the insulating layer is desirably in the range of 80% by mass or more and 99.9% by mass or less. Thereby, the insulating property of the insulating layer can be increased.

The insulating layer may include a binder. Examples of the binder include polytetrafluoroethylene (PTFE), polyvinylidene fluoride (PVdF), fluorine-based rubbers, and styrene butadiene rubber, and mixtures thereof. The content of the binder in the insulating layer is desirably in the range of 0.01% by mass or more and 20% by mass or less.

The thickness of the insulating layer can be set to 1 μm or more and 30 μm or less.

The second electrode may include an organic fiber film similar to the electrode structure of the embodiment on the active material-containing layer or the insulating layer.

(Separator)

The separator is preferably a self-supporting film type separator. The self-supporting film type separator is made of a porous film including polyethylene (PE), polypropylene (PP), cellulose or polyvinylidene fluoride (PVdF), or a synthetic resin non-woven fabric. From a safety viewpoint, it is preferable to use a porous film made of polyethylene or polypropylene. Such a porous film melts at a certain temperature to break a current.

(Manufacturing Method)

The battery unit according to the embodiment is manufactured by, for example, the following method.

First, a slurry for forming active material-containing layers of the first electrode included in the electrode structure is prepared. The slurry for forming active material-containing layers is obtained by mixing and stirring an active material, optionally contained conductive agent and binder and solvent. The resulting slurry for forming active material-containing layers is applied to at least one surface of the current collector, and the coated film is dried. By applying a pressing process to the coated film after drying, the first electrode is obtained.

Next, the organic fiber film is formed on at least one active material-containing layer of the first electrode. The organic fiber film is preferably formed by an electrospinning method. Specifically, first, the above-described organic materials are dissolved in an organic solvent to prepare a raw material solution. As the organic solvent, any solvent may be used, examples which include dimethylacetamide (DMAc), dimethyl sulfoxide (DMSO), N,N-dimethylformamide (DMF), N-methylpyrrolidone (NMP), water, or alcohols. The concentration of the organic fibers in the raw material solution is, for example, within a range from 5 mass to 60 mass %.

Next, an electrospinning device is prepared. The electrospinning device includes a spinning nozzle, a high voltage generator applying a voltage to the spinning nozzle, and a metering pump supplying the raw material solution to the spinning nozzle. A raw material solution is discharged from the spinning nozzle toward the surface of the first electrode while the voltage is applied to the spinning nozzle using the high voltage generator. The discharged raw material solution becomes a thread shape, and approaches the first electrode while drawing a spiral shape. At this time, the raw material solution charged by the voltage applied to the spinning nozzle is drawn from the spinning nozzle toward the first electrode. Therefore, since the surface area of the raw material solution rapidly increases, the solvent is volatilized from the raw material solution, and the charge amount per unit volume of the raw material solution is increased. Therefore, the raw material solution is deposited on the first electrode as a nano-sized organic fiber in a state in which the solvent is almost completely volatilized.

Here, since the charged organic fiber is attracted to the oppositely charged first electrode by electrostatic force, the charged organic fiber is deposited on the first electrode over a region wider than a discharge port of the spinning nozzle. In particular, since the current collector and the tab are more easily charged than the active material-containing layer, the organic fiber is likely to be drawn onto the current collector and the tab.

In the organic fiber film obtained by electrospinning method, because charged organic fiber is disposed on the first electrode, an adhesion between the organic fiber and the first electrode is high, and they can be said to be integrated.

The applied voltage is appropriately determined according to solvent/solute species, boiling point/vapor pressure curves of the solvent, solution concentration, temperature, nozzle shape, distance between the sample and the nozzle, and the like. For example, the applied voltage sets a potential difference between the nozzle and the work to 0.1 kV to 100 kV. The supply rate of the raw material solution is also appropriately determined according to a solution concentration, a solution viscosity, a temperature, a pressure, an applied voltage, a nozzle shape, and the like. When the spinning nozzle is a syringe type, for example, the supply rate is set to 0.1 μl/min to 500 μl/min per nozzle. In addition, when the spinning nozzle is a multi-nozzle or a slit, the supply rate is determined according to an opening area of the nozzle.

By using the electrospinning device provided with the multi nozzle, the organic fiber film can be formed simultaneously on the principal surfaces of the active material-containing layers and the current collector tabs of both surfaces, and the side surfaces of the active material-containing layers.

The organic fiber film may be formed using an ink jet method, a jet dispenser method, or a spray coating method.

Next, a laminate of the organic fiber film and the first electrode formed as described above is subjected to a press processing, and the electrode structure is thereby obtained. A press method may be a roll press or a flat plate method. A press temperature is set to, for example, 20° C. to 200° C. The press temperature is preferably room temperature. The press processing is performed in such a manner that a ratio, (t1−t2)/t1, of a value (t1−t2) obtained by subtracting thickness t2 of the organic fiber film after press processing from thickness t1 of the organic fiber film before press processing, to the thickness t1 before press processing, i.e., a compression ratio, is within a range from 33% to 50%. With the compression ratio in this range, it is possible to obtain an electrode structure having a low coefficient of kinetic friction between the electrode structure and the substrate, and a large elongation amount of the organic fiber film.

That is, by increasing the compression ratio, a part of a plurality of organic fibers can be buried in the surface of the active material-containing layer. When a part of the organic fibers is immobilized in the active material-containing layer, friction force of a contact surface between the organic fiber film and the substrate is lowered, and the organic fiber film is less likely to peel off from the active material-containing layer. However, in the organic fiber film, if the proportion of organic fibers immobilized in the active material-containing layer is increased, the proportion of organic fibers released from the active material-containing layer is lowered. The released organic fibers are deposited on the active material-containing layer in a randomly oriented state. If the shape of the active material-containing layer film significantly changes, the released organic fibers can be deformed so as to be aligned in the deformation direction, and the released organic fibers can follow this shape change. That is, in the organic fiber film, if the proportion of organic fibers immobilized in the active material-containing layer is increased, the adhesion between the organic fiber film and the active material-containing layer is increased, whereas the proportion of organic fibers released from the active material-containing layer is lowered, resulting in a decrease in the elongation amount of the organic fiber film.

By laminating the electrode structure and the substrate obtained as described above through the organic fiber film, the battery unit according to the embodiment can be obtained. The second electrode as an example of the substrate can be obtained in the same manner as the first electrode. The insulating layer of the second electrode is obtained by applying the slurry containing the insulating particles, the optionally contained binder, and the solvent on the active material-containing layer of the second electrode, followed by drying the coated film. The slurry for forming insulating layers may be formed by coating at the same time as the slurry for forming active material-containing layers so as to be laminated on the slurry for active material-containing layers, and they are dried at the same time. For simultaneous coating of these slurries, for example, a coating device in which the first discharge port and the second discharge port are longitudinally located is used.

The battery unit according to the embodiment has a coefficient of kinetic friction between the electrode structure and the substrate of 0.8 or less, and includes an organic fiber film having elongation amount S of π×T/4 or more with respect to the thickness T of the first electrode. Therefore, the battery unit according to the embodiment is less likely to have an internal short circuit.

### Second Embodiment

According to the embodiment, an electrode group is provided. The electrode group includes a battery unit of the embodiment. If the battery unit of the embodiment includes a second electrode as a substrate, the battery unit may be used an electrode group. If the battery unit of the embodiment includes a separator as a substrate, the electrode group includes the battery unit of the embodiment and an opposed electrode. At least a part of the opposed electrode is opposed to an electrode structure through a separator. For the opposed electrode, the above-described second electrode may be used.

The electrode group of the embodiment may be a wound-type electrode group, or a laminated-type electrode group. The wound-type electrode group is obtained by spirally winding an electrode group followed by press processing. The laminated-type electrode group is obtained by cutting the electrode group into a predetermined size and laminating the cut electrode group in a thickness direction. The battery unit of the embodiment is suitably used as the wound-type electrode group.

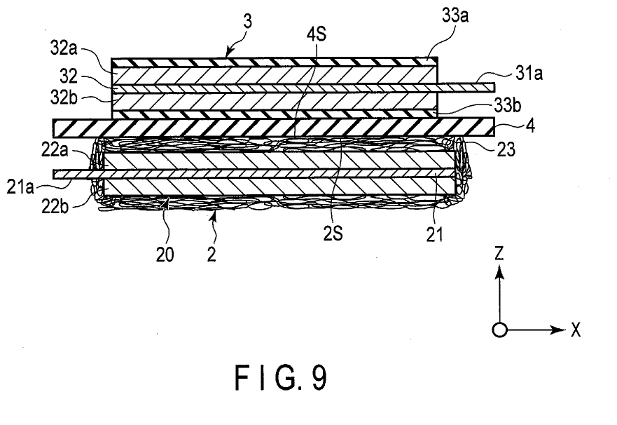

FIG. 9 is a cross-sectional view schematically illustrating an example of the electrode group according to the embodiment. The electrode group of FIG. 9 is an example in which a self-supporting film type separator 4 is used a substrate. The electrode group of FIG. 9 has the same structure as the battery unit 1 of FIG. 1 except that the self-supporting film type separator 4 is disposed between the electrode structure 2 and the second electrode 3. In the electrode group of FIG. 9, surface 4S of the self-supporting film type separator 4 and surface 2S of the electrode structure 2 are in contact with each other.

The electrode group of the embodiment includes the battery unit of the embodiment. Therefore, in the electrode group of the embodiment, an internal short circuit is less likely to occur.

### Third Embodiment

According to the embodiment, a secondary battery is provided. The secondary battery of the embodiment includes a battery unit of the embodiment. The secondary battery of the embodiment may include an electrode group of the embodiment instead of the battery unit of the embodiment.

The secondary battery of the embodiment may further contain a nonaqueous electrolyte. The secondary battery of the embodiment may further include a container member capable of containing an electrode group. The secondary battery of the embodiment may further include a first electrode terminal electrically coupled to the current collector tab of the first electrode, and a second electrode terminal electrically coupled to the current collector tab of the second electrode.

As the nonaqueous electrolyte, a liquid nonaqueous electrolyte prepared by dissolving an electrolyte in an organic solvent, a gel-form nonaqueous electrolyte in which a liquid electrolyte and a polymer material are combined, or the like is used. The liquid nonaqueous electrolyte can be prepared by, for example, dissolving an electrolyte in an organic solvent at a concentration of 0.5 mol/L or more and to 2.5 mol/L or less.

Examples of the electrolyte can include a lithium salt such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), or bistrifluoromethylsulfonylimide lithium [LiN(CF₃SO₂)₂], and mixtures thereof. As the electrolyte, those difficult to be oxidized even at a high potential are preferable, and LiPF₆ is most preferable.

Examples of the organic solvent include cyclic carbonates such as propylene carbonate (PC), ethylene carbonate (EC), and vinylene carbonate, chain carbonates such as diethyl carbonate (DEC), dimethyl carbonate (DMC), and methyl ethyl carbonate (MEC), cyclic ethers such as tetrahydrofuran (THF), 2 methyl tetrahydrofuran (2MeTHF), and dioxolane (DOX), chain ethers such as dimethoxy ethane (DME) and diethoxy ethane (DEE), γ-butyrolactone (GBL), acetonitrile (AN), and sulfolane (SL). These organic solvents can be used alone or can be used as a mixture of two or more kinds.

Examples of the polymer material may include polyvinylidene fluoride (PVdF), polyacrylonitrile (PAN), and polyethylene oxide (PEO).

As the nonaqueous electrolyte, a room temperature molten salt (ionic melt) containing lithium ions, a polymer solid electrolyte, an inorganic solid electrolyte, or the like may be used.

As the container member, for example, a metal container, a container made of a laminate film, or the like can be used.

The form of the secondary battery is not particularly limited, and for example, may take various forms such as a cylindrical shape, a flat shape, a thin shape, a prismatic shape, a coin shape, and the like.

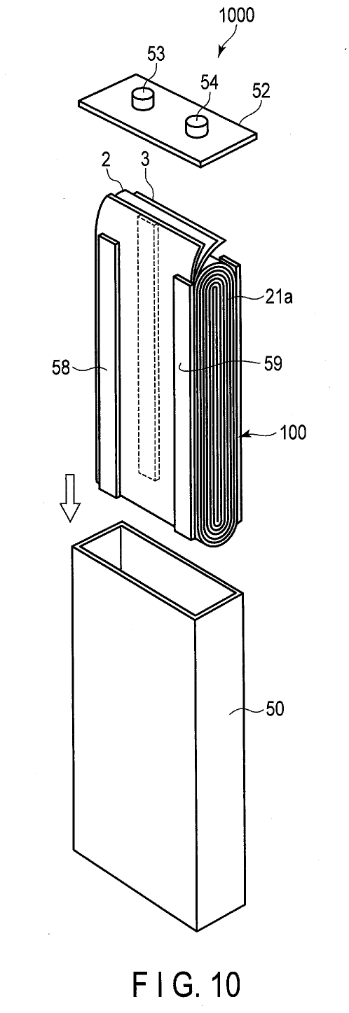

FIG. 10 is an exploded perspective view illustrating an example of a secondary battery according to the embodiment. FIG. 10 is a view illustrating an example of a secondary battery in which a prismatic-shaped metal container is used as a container member. A secondary battery 1000 of FIG. 10 includes a container member 50, a wound-type electrode group 100, a lid 52, a first electrode terminal 53, a second electrode terminal 54, a first electrode lead 58, a second electrode lead 59, and a nonaqueous electrolyte (not shown). The wound-type electrode group 100 has a structure in which the electrode group of the embodiment is wound in a flat spiral shape. In the wound-type electrode group 100, a current collector tab 21a wound in a flat spiral shape is located on an end surface in a winding axis direction, and a current collector tab 31a wound in a flat spiral shape is located on another end surface in the winding axis direction. A nonaqueous electrolyte (not shown) is held in or impregnated with the electrode group 100. A first electrode lead 58 is electrically connected to the current collector tab 21a and also electrically connected to the first electrode terminal 53. A second electrode lead 59 is electrically connected to the current collector tab 31a and also electrically connected to the second electrode terminal 54. The electrode group 100 is disposed in the container member 50 such that the first electrode lead 58 and the second electrode lead 59 face the main surface side of the container member 50. The lid 52 is fixed to an opening of the container member 50 by welding or the like. The first electrode terminal 53 and the second electrode terminal 54 are each attached to the lid 52 through an insulating hermetic seal member (not shown).

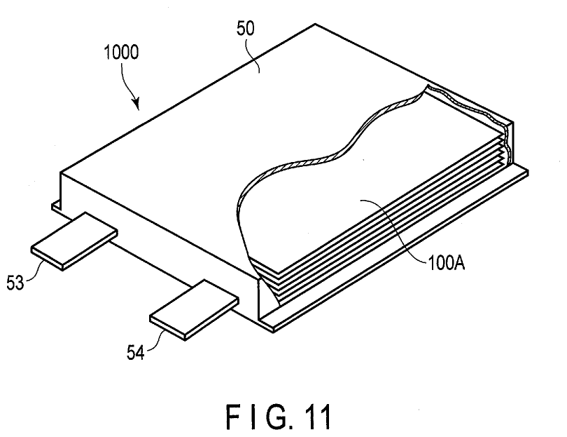

FIG. 11 is a partially cut perspective view illustrating another example of the secondary battery according to the embodiment. FIG. 11 is a view illustrating an example of a secondary battery using a laminate film as a container member. A secondary battery 1000 shown in FIG. 11 includes a container member 50 formed of a laminated film, a laminated-type electrode group 100A, a first electrode terminal 53, a second electrode terminal 54, and a nonaqueous electrolyte (not shown). The electrode group 100A has a structure in which electrode groups of the embodiment are laminated in the thickness direction. A nonaqueous electrolyte (not shown) is held in or impregnated with the electrode group 100A. The current collector tab of the first electrode is electrically connected to the first electrode terminal 53. The current collector tab of the second electrode is electrically connected to the second electrode terminal 54. As shown in FIG. 11, each tip of the first electrode terminal 53 and the second electrode terminal 54 protrudes to the outside from one side of the container member 50 at a distance from each other.

The secondary battery of the embodiment described above includes the battery unit of the embodiment. Therefore, in the secondary battery of the embodiment, an internal short circuit is less likely to occur.

### EXAMPLES

### Example 1

First, a first electrode was prepared as a negative electrode. A negative electrode active material, conductive agent, binder, and solvent were mixed and stirred to prepare a slurry for forming a negative electrode active material-containing layer. As the negative electrode active material, titanium oxide (Li₄Ti₅O₁₂) was used. As the conductive agent, carbon black was used. As the binder, polyvinylidene fluoride was used. A mass ratio of the negative electrode active material, conductive agent, and binder in the slurry was 90:5:5. This slurry was applied to both surfaces of a negative electrode current collector, the coated film was dried, and subjected to press processing, thereby obtaining a first electrode. As the negative electrode current collector, an aluminum foil having a thickness of 20 μm was used. Each thickness of the active material-containing layers of both surfaces was 50 μm, and the thickness of the first electrode was 120 μm.

Next, an organic fiber film was provided on the surface of the first electrode. First, a raw material solution was prepared by dissolving an organic material in an organic solvent. As the organic material, polyimide was used. As the organic solvent, DMAc was used. The concentration of the raw material solution in the war material solution was 20 mass %. Using the raw material solution, organic fibers were deposited on the surface of the first electrode by the above-described electrospinning method to obtain a laminate of the first electrode and a deposit of organic fibers. The deposit of organic fibers had a thickness of 6 μm.

Next, the laminate was subjected to roll press processing. The roll press processing was performed so that the compression rate was 50.0%. Thereafter, excessive organic fibers on the current collector tab of the first electrode were removed, obtaining an electrode structure provided with the organic fiber film illustrated in FIGS. 1 and 6. The organic fiber film had a thickness of 3 μm.

Next, a second electrode was prepared as a positive electrode. A positive electrode active material, conductive agent, binder, and solvent were mixed and stirred to prepare a slurry for forming a positive electrode active material-containing layer. As the positive electrode active material, LiNi_{0.33}Co_{0.33}Mn_{0.33}O₂ was used. As the conductive agent, carbon black was used. As the binder, polyvinylidene fluoride was used. A mass ratio of the positive electrode active material, conductive agent, and binder in the slurry was 90:5:5. The slurry was applied to both surfaces of a positive electrode current collector, the coated film was dried and then subjected to press processing, thereby obtaining a second electrode. As the positive electrode current collector, an aluminum foil having a thickness of 20 μm was used.

The first electrode and the second electrode obtained as described above were laminated to face each other through the organic fiber film, thereby obtaining the battery unit.

### Example 2

A battery unit was prepared by the same method as in Example 1 except that the compression rate was set to 33.3%.

### Example 3

A battery unit was prepared by the same method as in Example 1 except that niobium titanium composite oxide (Nb₂TiO₇) was used as a negative electrode active material.

### Example 4

A battery unit was prepared by the same method as in Example 1 except that an insulating layer was provided on the surface of the second electrode. The insulating layer was provided in the following method. First, insulating particles, binder, and solvent were mixed and stirred to prepare a slurry for forming an insulating layer. As the insulating particles, alumina having an average particle size of 1.0 μm was used. As the binder, polyvinylidene fluoride was used. A mass ratio of the insulating particles and the binder in the slurry was 80:20. The slurry was applied simultaneously on the positive electrode current collector so as to be laminated on the slurry for forming the active material-containing layer of the second electrode, and the coated film was then dried, forming a laminate of the active material-containing layer and the insulating layer. Thereafter, the laminate was subjected to press processing. The insulating layer had a thickness of 5 μm.

### Example 5

A battery unit was prepared by the same method as in Example 4 except that the solid electrolyte (Li₇La₃Zr₂O₁₂) having an average particle size of 0.8 μm was used as the insulating particles.

### Example 6

A battery unit was prepared by the same method as in Example 4 except that the thickness of the negative electrode active material-containing layers of both surfaces was set to 20 μm.

### Comparative Example 1

A battery unit was prepared by the same method as in Example 1 except that the compression rate was set to 83.3%.

### Comparative Example 2

A battery unit was prepared by the same method as in Example 1 except that the compression rate was set to 16.7%.

<Measurement of Coefficient of Kinetic Friction>

For the battery unit obtained in Examples and Comparative Examples, the coefficient of kinetic friction was measured by the above-described method. The results thereof are shown in Table 2.

<Measurement of Elongation Amount of Organic Fiber Film>

The electrode structure was taken out from the battery unit obtained in Examples and Comparative Examples, and the elongation amount of the organic fiber film was measured by the above-described method. The results thereof are shown in Table 2.

<Evaluation of Battery Performance>

A secondary battery was prepared using the battery unit obtained in Examples and Comparative Examples. First, the battery unit was spirally wound and subjected to press processing, obtaining a flat wound-type electrode group. After the wound-type electrode group was put in the container, the nonaqueous electrolyte was injected, and the container was sealed, obtaining a secondary battery. As the nonaqueous electrolyte, one in which LiPF₆ was dissolved in ethylene carbonate was used.

The self-discharge performance of the obtained secondary battery was evaluated using a potentiostat. First, the secondary battery was charged so that the state-of-charge (SOC) was 100%, and then stored for 2 days in the 25° C. environment. Thereafter, the discharge capacity of the secondary battery was measured. By setting the discharge capacity before storage to 100%, a value representing the discharge capacity after storage was defined as a remaining capacity rate. The results thereof are shown in Table 2.

In Table 1 below, the structures of the battery units of Examples and Comparative Examples are summarized.

TABLE 1

| | Electrode Structure | | | | | Second Electrode | |
|---|---|---|---|---|---|---|---|
| | | | Thickness before | Thickness after | | | Thickness of |
| | | Thickness | Compression | Compression | Compression | Insulating | Insulating |
| | Active Material | T(μm) | (μm) | (μm) | Rate | Particles | Layer (μm) |
| Example 1 | Titanium Oxide | 120 | 6 | 3 | 50.0% | — | — |
| Example 2 | Titanium Oxide | 120 | 6 | 4 | 33.3% | — | — |
| Example 3 | Niobium Titanium | 120 | 6 | 3 | 50.0% | — | — |
| | Composite Oxide | | | | | | |
| Example 4 | Titanium Oxide | 120 | 6 | 3 | 50.0% | Alumina | 5 |
| Example 5 | Titanium Oxide | 120 | 6 | 3 | 50.0% | Solid Electrolyte | 5 |
| Example 6 | Titanium Oxide | 60 | 6 | 3 | 50.0% | Alumina | 5 |
| Comparative | Titanium Oxide | 120 | 6 | 1 | 83.3% | — | — |
| Example 1 | | | | | | | |
| Comparative | Titanium Oxide | 120 | 6 | 5 | 16.7% | — | — |
| Example 2 | | | | | | | |

In Table 2 below, the evaluation results of the battery units of Examples and Comparative Examples are summarized.

TABLE 2

| | Electrode Structure | | | |
|---|---|---|---|---|
| | | Elongation | Coefficient of | Secondary Battery |
| | π × T/4 | Amount S | Kinetic | Remaining |
| | (μm) | (μm) | Friction | Capacity Rate |
| Example 1 | 94.25 | 150 | 0.6 | 99.98 |
| Example 2 | 94.25 | 200 | 0.8 | 99.99 |
| Example 3 | 94.25 | 150 | 0.6 | 99.98 |
| Example 4 | 94.25 | 150 | 0.6 | 99.98 |
| Example 5 | 94.25 | 150 | 0.6 | 99.98 |
| Example 6 | 47.12 | 150 | 0.6 | 99.98 |
| Comparative | 94.25 | 50 | 0.6 | 99.25 |
| Example 1 | | | | |
| Comparative | 94.25 | 400 | 0.9 | 98.95 |
| Example 2 | | | | |

As shown in Table 2, the secondary batteries using the battery units of Examples 1 to 6, having a coefficient of kinetic friction of 0.8 or less and an elongation amount of the organic fiber film of π×T/4 or more, had a larger remaining capacity rate than the second batteries using the battery units of Comparative Examples 1 and 2 which do not satisfy the requirements.

As is apparent from the comparison between Example 1 and Example 3, even when the type of the negative electrode active material was changed, excellent internal short circuit suppression performance was realized. Furthermore, as is apparent from the comparison between Example 1 and Examples 4 and 5, even when the second electrode included the insulating layer, excellent internal short circuit suppression performance was realized.

The battery unit according to at least one embodiment has a coefficient of kinetic friction between the electrode structure and the substrate of 0.8 or less, and includes an organic fiber film having an elongation amount S of π×T/4 or more with respect to the thickness T of the first electrode. Therefore, the battery unit according to the embodiment is less likely to have an internal short circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery unit, comprising:
an electrode structure that comprises a first electrode comprising an active material-containing layer, and an organic fiber film provided on the active material-containing layer; and
a substrate that is in contact with the organic fiber film,
a coefficient of kinetic friction between the electrode structure and the substrate being 0.8 or less,
elongation amount S of the organic fiber film and thickness T of the first electrode satisfying the following equation (1):
S≥π×T/4 (1)

2. The battery unit according to claim 1, wherein the substrate is a second electrode that comprises an insulating layer, the insulating layer being in contact with the organic fiber film and comprising insulating particles.

3. The battery unit according to claim 2, wherein the insulating particles comprise at least one of oxide particles or solid electrolyte particles.

4. The battery unit according to claim 1, wherein the organic fiber film comprises at least one organic material selected from the group consisting of polyamideimide, polyamide, polyolefin, polyether, polyimide, polyketone, polysulfone, cellulose, polyvinyl alcohol, and polyvinylidene fluoride.

5. The battery unit according to claim 1, wherein the first electrode has a thickness of 15 μm or more and 240 μm or less.

6. The battery unit according to claim 1, wherein the first electrode comprises at least one of a titanium-containing oxide or a niobium titanium-containing oxide.

7. A secondary battery comprising the battery unit according to claim 1.
